(19) United States
(12) Patent Application Publication
(10) Pub. No.: US 2026/0300885 A1
(43) Pub. Date: Oct. 1, 2026

(54) SYSTEM AND METHOD FOR USE WITH AN ENTERPRISE APPLICATION ENVIRONMENT FOR DETERMINATION OF PEER BENCHMARKS

(71) Applicant: ORACLE INTERNATIONAL CORPORATION, Redwood Shores, CA (US)

(72) Inventors: Manisha Gupta, San Ramon, CA (US); Nupur Joshi, Pleasanton, CA (US); Saugata Chowdhury, Sunnyvale, CA (US); Anirban Majumdar, Hyderabad (IN); Niraj Kumar, Pleasanton, CA (US)

(21) Appl. No.: 19/409,097

(22) Filed: Dec. 4, 2025

Related U.S. Application Data
(60) Provisional application No. 63/780,744, filed on Mar. 31, 2025.

(51) Int. Cl. G06Q 10/0639

(52) U.S. Cl. CPC G06Q 10/06393

(57) ABSTRACT

In accordance with an embodiment, described herein is a system and method for use with an enterprise application environment for generating data analytics, including determination and visualization of peer benchmarks. In accordance with an embodiment, the system operates to receive an enterprise data, for example from an organization's enterprise software environment, and provides computer-executable processes and data structures for use in configuring and generating peer performance indicators or benchmarks. In accordance with an embodiment, the system provides a user interface by which a user can define templates, domains, segments, and members that comprise peer groups, or customize peer definitions to suit particular requirements. The system can then assess the enterprise data across various dimensions or measures, and generate key performance indicators, dashboards, or scorecards, for example as a two-dimensional data visualization that compares peer-to-peer characteristics, benchmarks, or other insights.

### CLAIM OF PRIORITY AND CROSS-REFERENCE TO RELATED APPLICATIONS

This application claims the benefit of priority to U.S. Provisional Patent Application titled “SYSTEM AND METHOD FOR USE WITH AN ENTERPRISE APPLICATION ENVIRONMENT FOR DETERMINATION OF PEER BENCHMARKS”, Application No. 63/780,744, filed Mar. 31, 2025; which above application and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics, and computer-based methods of providing business intelligence data, key performance indicators, dashboards, or scorecards; and are particularly directed to systems and methods for use with an enterprise application environment for determination of peer benchmarks.

### BACKGROUND

Generally described, within an enterprise organization, data analytics enables computer-based examination of amounts of data, to derive conclusions or other information from the data. For example, business intelligence tools can be used to provide an organization's users with information describing their enterprise data, in a format that enables the users to make strategic business decisions.

Examples of various types of data analytics of interest to enterprise organizations include those related to Enterprise Resource Planning (ERP), Human Capital Management (HCM), Human Resources (HR), Customer Experience (CX), Supply Chain Management (SCM), Enterprise Performance Management (EPM), or other types of data and data analytics use cases. Information describing an enterprise organization's resources can be useful in assisting the organization to make analytics-based decisions based on such data.

However, present systems do not readily allow a business user to configure a data analytics environment to compare, for example, a particular organization unit or team, with one or more peers, for purposes of comparing performance metrics or other characteristics.

### SUMMARY

In accordance with an embodiment, described herein is a system and method for use with an enterprise application environment for generating data analytics, including determination and visualization of peer benchmarks.

In accordance with an embodiment, the system operates to receive an enterprise data, for example from an organization's enterprise software environment, and provides computer-executable processes and data structures for use in configuring and generating peer performance indicators or benchmarks.

In accordance with an embodiment, the system provides a user interface by which a user can define templates, domains, segments, and members that comprise peer groups, or customize peer definitions to suit particular requirements. The system can then assess the enterprise data across various dimensions or measures, and generate key performance indicators, dashboards, or scorecards, for example as a two-dimensional data visualization that compares peer-to-peer characteristics, benchmarks, or other insights.

### BRIEF DESCRIPTION OF THE DRAWINGS

FIG. 1 illustrates an example data analytics environment, in accordance with an embodiment.

FIG. 2 further illustrates an example data analytics environment, in accordance with an embodiment.

FIG. 3 further illustrates an example data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 illustrates an example use of a data analytics environment to provide a visualization of key performance indicators or scorecards, in accordance with an embodiment.

FIG. 8 illustrates the use of an area of responsibility data in providing a visualization of key performance indicators or scorecards, in accordance with an embodiment.

FIG. 9 illustrates a system for use with an enterprise application environment for determination of peer benchmarks, in accordance with an embodiment.

FIG. 10 illustrates a process for configuration of a peer benchmark, in accordance with an embodiment.

FIG. 11 further illustrates a process for configuration of a peer benchmark, in accordance with an embodiment.

FIG. 12 illustrates an example user interface for use in configuring a peer benchmark, in accordance with an embodiment.

FIG. 13 further illustrates an example user interface for use in configuring a peer benchmark, in accordance with an embodiment.

FIG. 14 further illustrates an example user interface for use in configuring a peer benchmark, in accordance with an embodiment.

FIG. 15 illustrates the use of a process for generation of a peer benchmark, in accordance with an embodiment.

FIG. 16 further illustrates the process for generation of a peer benchmark, in accordance with an embodiment.

FIG. 17 illustrates an example user interface for displaying key performance indicators, dashboards, or scorecards, in accordance with an embodiment.

FIG. 18 illustrates an example use of the user interface to display peer benchmarks, in accordance with an embodiment.

FIG. 19 illustrates an example process for use with an enterprise application environment for determination of peer benchmarks, in accordance with an embodiment.

FIG. 20 illustrates an example user interface for configuring a system to generate and display peer benchmarks, in accordance with an embodiment.

FIG. 21 further illustrates an example user interface, in accordance with an embodiment.

FIG. 22 further illustrates an example user interface, in accordance with an embodiment.

FIG. 23 further illustrates an example user interface, in accordance with an embodiment.

FIG. 24 further illustrates an example user interface, in accordance with an embodiment.

FIG. 25 further illustrates an example user interface, in accordance with an embodiment.

FIG. 26 further illustrates an example user interface, in accordance with an embodiment.

FIG. 27 further illustrates an example user interface, in accordance with an embodiment.

FIG. 28 further illustrates an example user interface, in accordance with an embodiment.

FIG. 29 further illustrates an example user interface, in accordance with an embodiment.

FIG. 30 further illustrates an example user interface, in accordance with an embodiment.

FIG. 31 further illustrates an example user interface, in accordance with an embodiment.

FIG. 32 further illustrates an example user interface, in accordance with an embodiment.

### DETAILED DESCRIPTION

Generally described, within an enterprise organization, data analytics enables computer-based examination of amounts of data, to derive conclusions or other information from the data. For example, business intelligence tools can be used to provide an organization's users with information describing their enterprise data, in a format that enables the users to make strategic business decisions.

Examples of various types of data analytics of interest to enterprise organizations include those related to Enterprise Resource Planning (ERP), Human Capital Management (HCM), Human Resources (HR), Customer Experience (CX), Supply Chain Management (SCM), Enterprise Performance Management (EPM), or other types of data and data analytics use cases. Information describing an enterprise organization's resources can be useful in assisting the organization to make analytics-based decisions based on such data.

However, present systems do not readily allow a business user to configure a data analytics environment to compare, for example, a particular organization unit or team, with one or more peers, for purposes of comparing performance metrics or other characteristics.

In accordance with an embodiment, described herein is a system and method for use with an enterprise application environment for generating data analytics, including determination and visualization of peer benchmarks. In accordance with an embodiment, the system operates to receive an enterprise data, for example from an organization's enterprise software environment, and provides computer-executable processes and data structures for use in configuring and generating peer performance indicators or benchmarks. In accordance with an embodiment, the system provides a user interface by which a user can define templates, domains, segments, and members that comprise peer groups, or customize peer definitions to suit particular requirements. The system can then assess the enterprise data across various dimensions or measures, and generate key performance indicators, dashboards, or scorecards, for example as a two-dimensional data visualization that compares peer-to-peer characteristics, benchmarks, or other insights.

### Data Analytics Environments

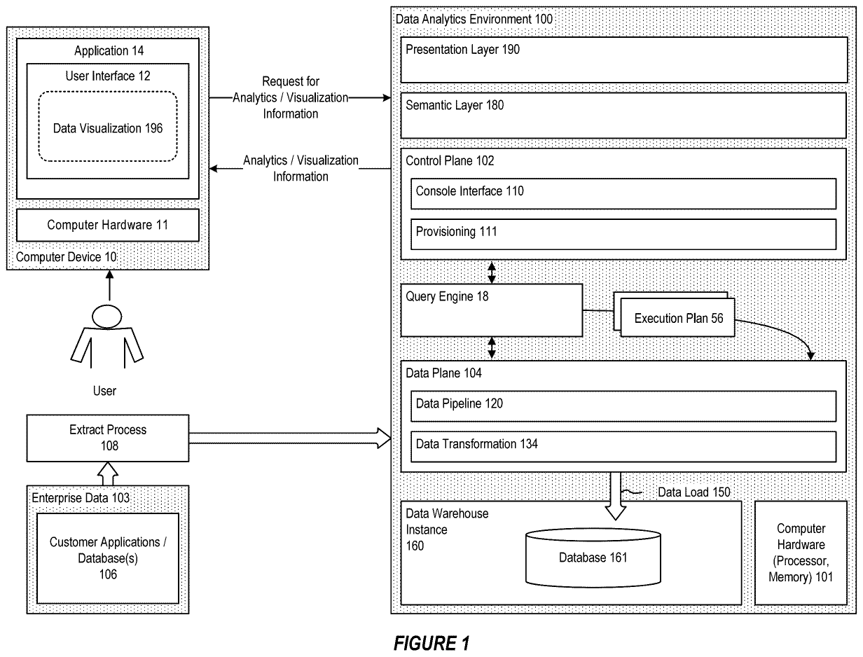

FIG. 1 illustrates an example data analytics environment, in accordance with an embodiment.

The embodiment illustrated in FIG. 1 is provided for purposes of illustrating an example data analytics environment in association with which various embodiments described herein can be used. The components and processes illustrated in FIG. 1 and as described elsewhere herein with regard to various other embodiments, can be provided as software or program code executable by, for example, a cloud computing system, or other suitably-programmed computer system.

As illustrated in FIG. 1, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract data from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for purposes of providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

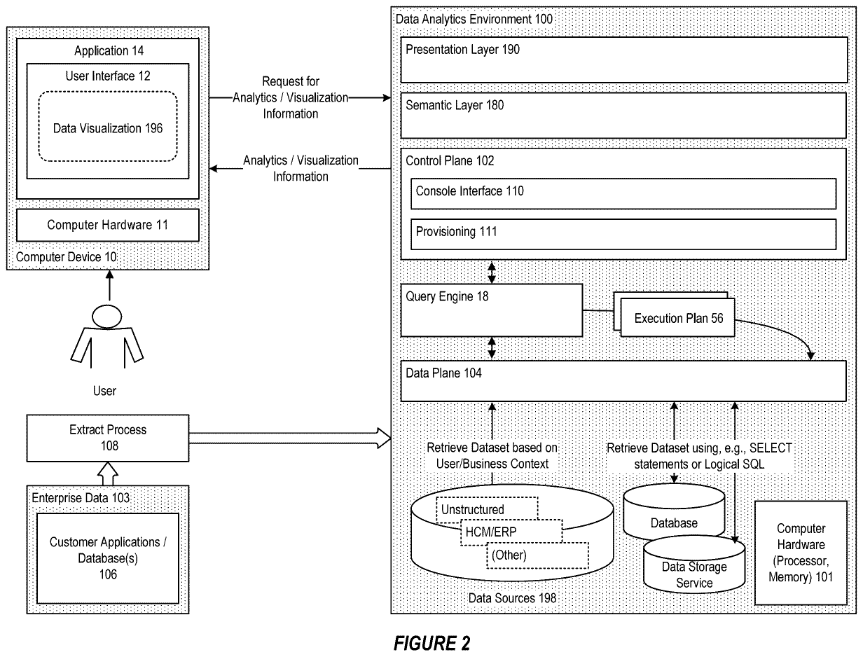

FIG. 2 further illustrates an example data analytics environment, in accordance with an embodiment.

As illustrated in FIG. 2, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), Human Resources (HR), Customer Experience (CX), Supply Chain Management (SCM), Enterprise Performance Management (EPM), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

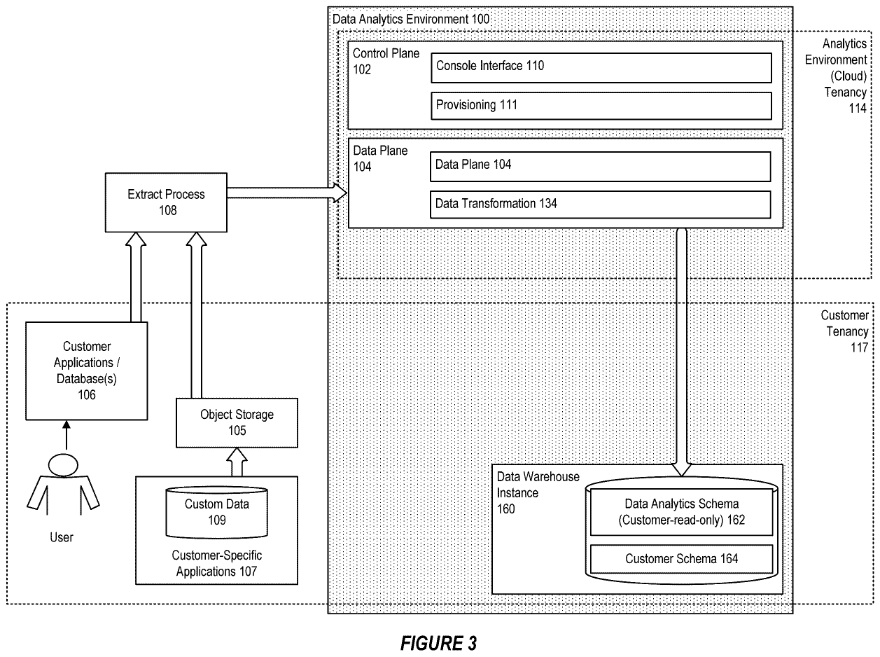

FIG. 3 further illustrates an example data analytics environment, in accordance with an embodiment.

As illustrated in FIG. 3, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

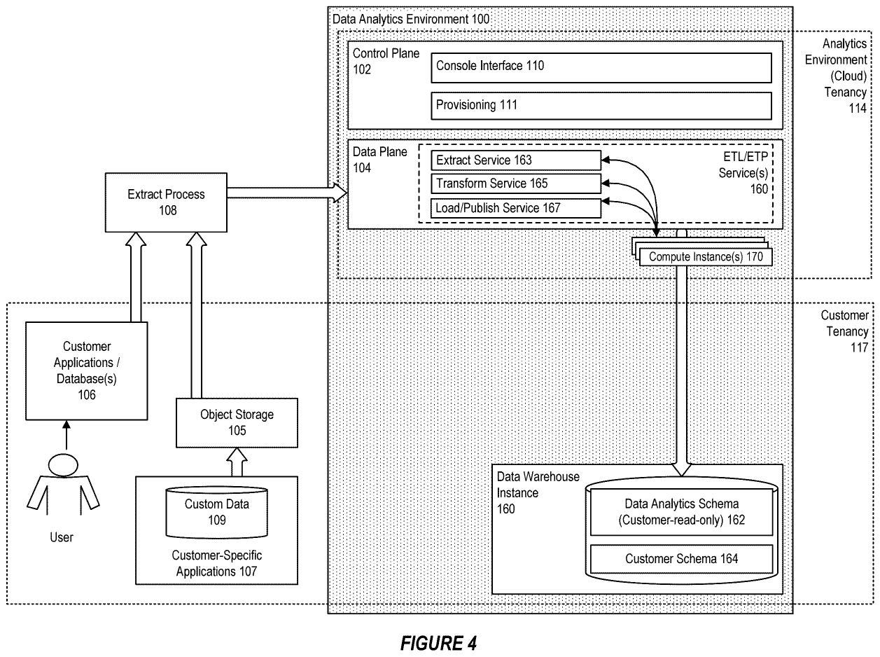

FIG. 4 further illustrates an example data analytics environment, in accordance with an embodiment.

As illustrated in FIG. 4, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

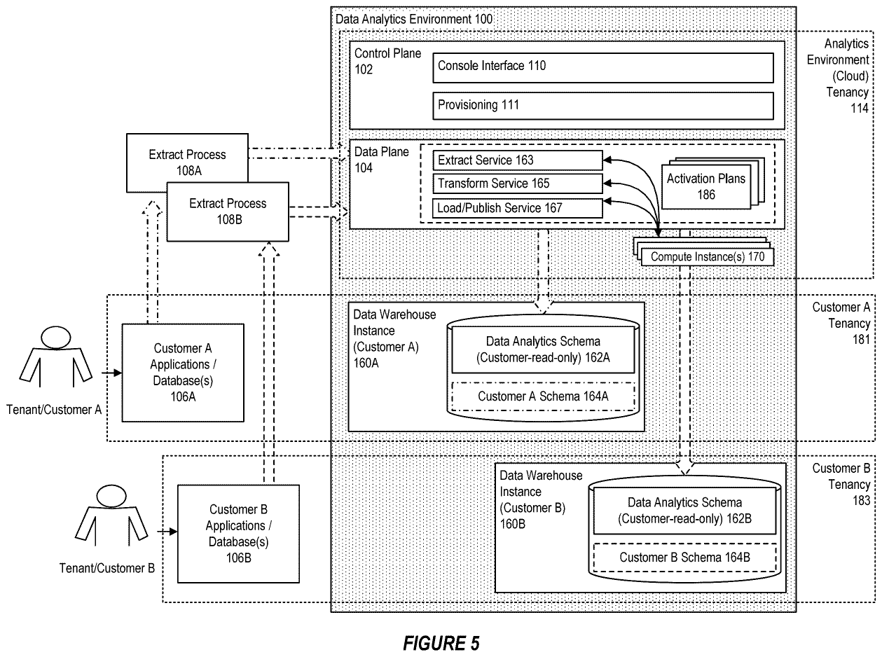

FIG. 5 further illustrates an example data analytics environment, in accordance with an embodiment.

As illustrated in FIG. 5, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

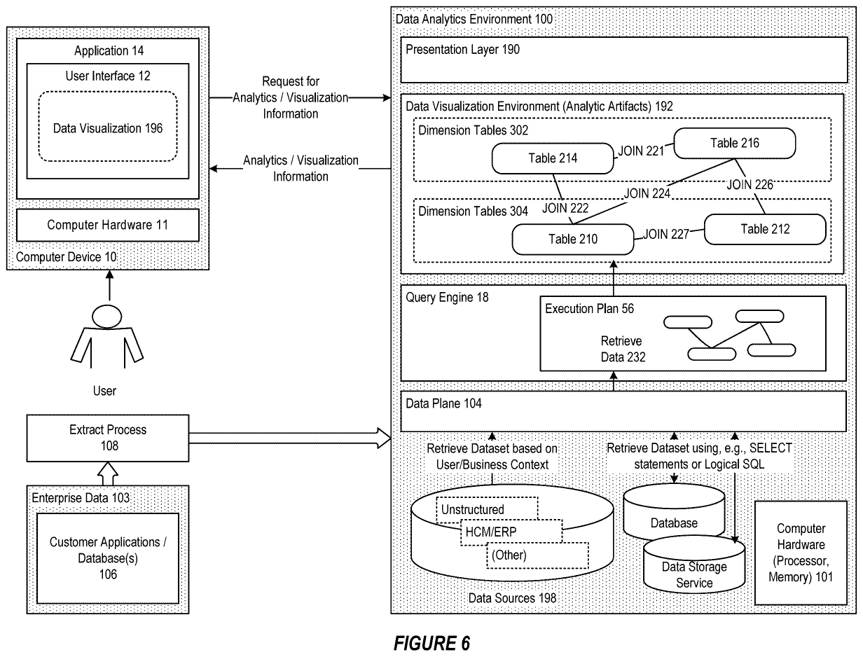

FIG. 6 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 6, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Evaluation, Implementation, and Refinement of Scorecards

Within an enterprise organization, business executives are tasked with not only making effective decisions regarding the workforce, but also with a need to interpret enterprise data and identify root causes as issues arise. A particular area of interest is improving Human Resources (HR) effectiveness, for example to examine ways to reduce employee termination headcount, or the amount of employee absences.

Within a typical organization, the ratio of HR representatives to employees may be of the order 1:100, with varying ratios based on the size or needs of the organization. Different areas of responsibility can also be associated with each HR representative that effectively provide a segregation of duties amongst the various members of the HR workforce, with particular HR representatives assigned to different parts of the organization to build, maintain, and grow.

In some environments, a variety of key measures or metrics are used to assess, quantify, or provide an indication of the effectiveness of an organization group. For example, a team effectiveness KPI can be used to measure effectiveness of a particular team by assessing its attrition rate, cost, requisition filling rate, or engagement survey score etc., of the team in comparison with the rest of the organization. Such key measures help executives to identify specific managers with high performing teams, and/or assess potential areas of improvement.

Following on the above example, when a particular team has a very high attrition rate, an insufficient headcount, or such talent scarcity, a manager may not be able to resolve this issue alone, and will generally need to partner with a respective HR representatives. Although such HR representatives may not be directly involved in an organization's daily business, their input has a considerable impact on the organization meeting the needs of its internal requirements or external customers, by hiring, retaining, and growing the right talent.

As such, for executives of any organization, it is not only important to have the right HR strategies in place, but also an effective means of evaluating, implementing, and refining that HR strategy.

In accordance with an embodiment, the systems and methods described herein can be used to provide evaluation, implementation, and refinement of key performance indicators, dashboards, or scorecards, for example human resource (HR) scorecards, for use in an enterprise organization's analytics-based decision-making.

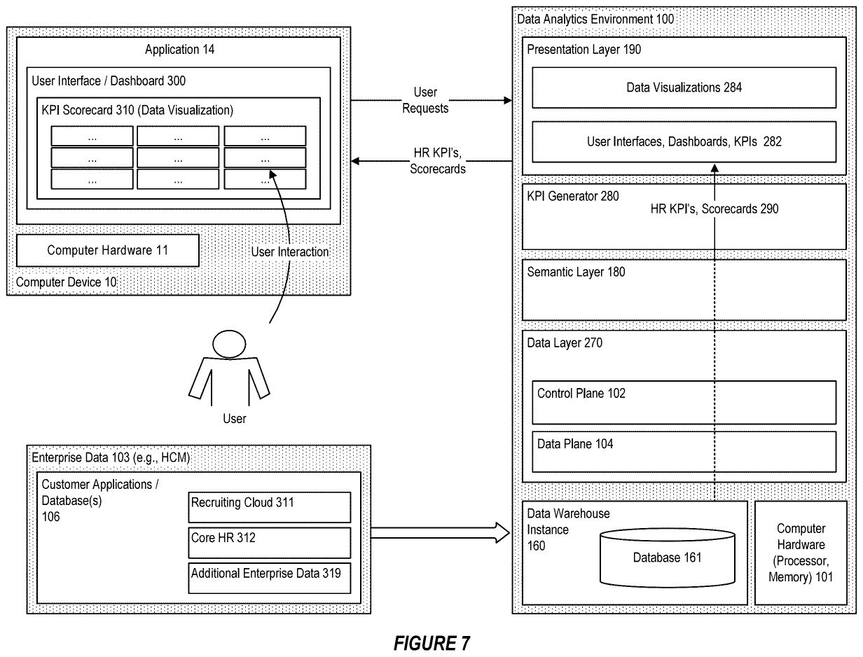

FIG. 7 illustrates an example use of a data analytics environment to provide a visualization of key performance indicators or scorecards, in accordance with an embodiment.

As illustrated in FIG. 7, in accordance with an embodiment, a data analytics environment, for example as described above, can include a KPI generator 280 that receives information via a data layer 270 from a data warehouse instance, and enables generation of enterprise data (e.g., HR) KPIs or scorecards 290, associated with the enterprise organization.

In accordance with an embodiment, the system can be accessed by a user using a client computer device, for example as described above. In response to a request, the system can receive, from the data warehouse instance, an (e.g., HR) enterprise data, and generate a user interface, dashboard, or KPI 282, for use as one or more data visualizations 284, and for subsequent display at a client user interface or dashboard 300, for example as a two-dimensional KPI scorecard 310, matrix, chart, or other data display or visualization format.

When used with HR enterprise data, such data can include for example, a recruiting cloud data 311, core HR data 312, or additional HR data 319, as further described below.

### Area of Responsibility Data

In accordance with an embodiment, the system can use an area of responsibility (AOR) data, for example as provided by a customer's Human Capital Management (HCM) data, e.g., a Fusion Data Intelligence platform, for use in visualizing key measures or metrics at a level of HR representative.

In accordance with an embodiment, an area of responsibility (AOR) data allows the customer to set security roles, based on a person's scope of responsibility, which determines, for example, which records they can see or act on. This approach improves security performance and reduces the number of profiles and data roles that must be managed and updated as people's roles change within the organization.

Organizations may have varied needs for managing data security, from granting broad access, to replicating the exact access granted in their HCM data. To support this, when HCM data is received into the data analytics environment, the security associated with the HCM data can be used to configure data access, for example by business unit, legal employer, country, or department.

In accordance with an embodiment, the data analytics environment can extract AOR data from a customer's HCM data, and load it into a data warehouse instance, as generally described above. Each customer (tenant) of the environment can be associated with their own customer tenancy; and can be additionally provided with read-only access to the data analytics schema. The AOR data can be seeded in an immutable data analytics schema, which can then be supplemented by customer-specific data as needed.

In accordance with an embodiment, the system can then compare, based on assessing the AOR data, various measures or metrics at a level of HR representative, such as, for example: headcount; male/female gender ratio; salary; attrition; retention; new hire; new hire attrition; voluntary/involuntary termination; workers with approved/rejected/withdrawn absences; count of approved absences; total absence hours/total absence days; high performer count/low performer count/medium performer count; overall performance evaluation process completion; overall goal setting process completion; learning hours; total openings; total job requisition; total applications.

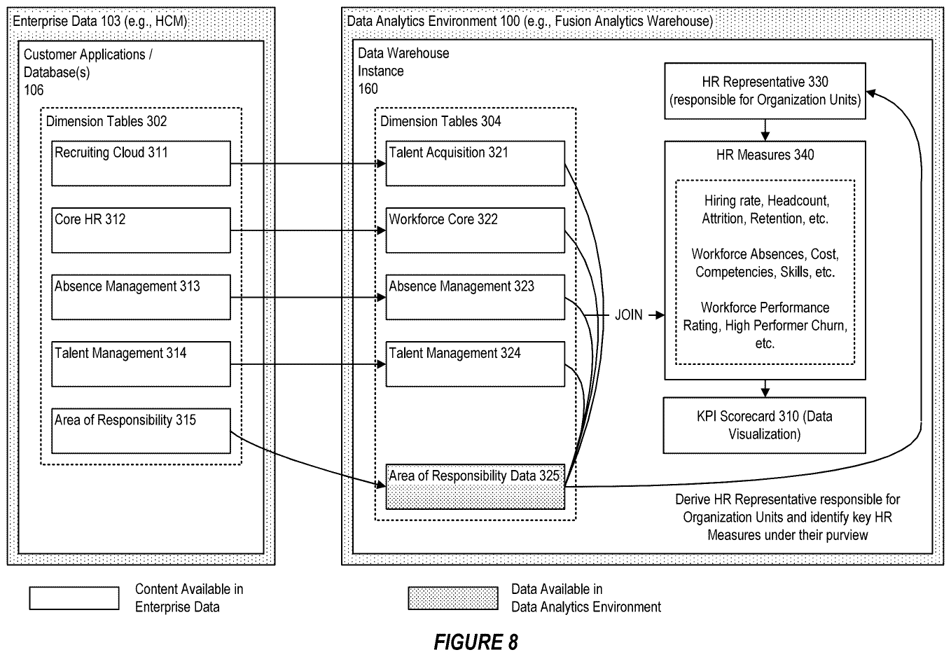

FIG. 8 illustrates the use of an area of responsibility data in providing a visualization of key performance indicators or scorecards, in accordance with an embodiment.

As illustrated in FIG. 8, in accordance with an embodiment, an enterprise data 103, for example a customer's HCM database, operates as a source of truth from which enterprise data such as HR data can be extracted and receiving in the data analytics environment.

In accordance with an embodiment, such HR data can include for example, a recruiting cloud data (e.g., recruiting date), or core HR data (e.g., employee lifecycle, hiring, promotion details) as described above, and/or additional HR data such as absence management data 313, talent management data 314 (e.g., performance review, language skills), and area of responsibility data 315.

In accordance with an embodiment, each of the data present in the enterprise data can be extracted, transformed, and loaded into a data warehouse instance as described above, as a corresponding talent acquisition data 321 workforce core data 322, absence management data 323, and talent management data 324. The data analytics environment can then join the several data sets with its own sets of data, including AOR data 325, in order to (a) derive one or more HR representative 330 responsible for particular organization units, during particular periods of time; and (b) identify key measures or metrics 340 under the purview of, or otherwise associated with those HR representatives, for use in generating a KPI scorecard reflecting such relationships.

In accordance with an embodiment, use of an area of responsibility data enables not only HR managers, but various HR representatives for all sections of organizations to be identified; for example, compensation representatives responsible for governing overall fairness in compensation planning and distribution process; or HR representatives responsible for overall hiring, absence policies, learning initiatives. By bringing this data into the data warehouse, in addition to simplifying security configuration, the system can be used to identify an individual HR representative for various organizational aspects.

For example, in accordance with an embodiment, a performance KPI can be generated to illustrate changes in the data associated with particular responsible persons or HR representative over different periods of time.

In accordance with an embodiment, the system can retrieve into the data analytics environment an enterprise data comprising one or more organization entity datasets, and derive, based on assessing an area of responsibility data associated with the organization entity datasets, one or more entity (e.g., HR) representatives responsible for particular organization units, and identify key measures associated with each entity representative.

### Determination of Peer Benchmarks

In accordance with an embodiment, described herein is a system and method for use with an enterprise application environment for generating data analytics, including determination and visualization of peer benchmarks.

In accordance with an embodiment, the system operates to receive an enterprise data, for example from an organization's enterprise software environment, and provides computer-executable processes and data structures for use in configuring and generating peer performance indicators or benchmarks.

In accordance with an embodiment, the system provides a user interface by which a user can define templates, domains, segments, and members that comprise peer groups, or customize peer definitions to suit particular requirements. The system can then assess the enterprise data across various dimensions or measures, and generate key performance indicators, dashboards, or scorecards, for example as a two-dimensional data visualization that compares peer-to-peer characteristics, benchmarks, or other insights.

### Peer Benchmark Configuration and Generation

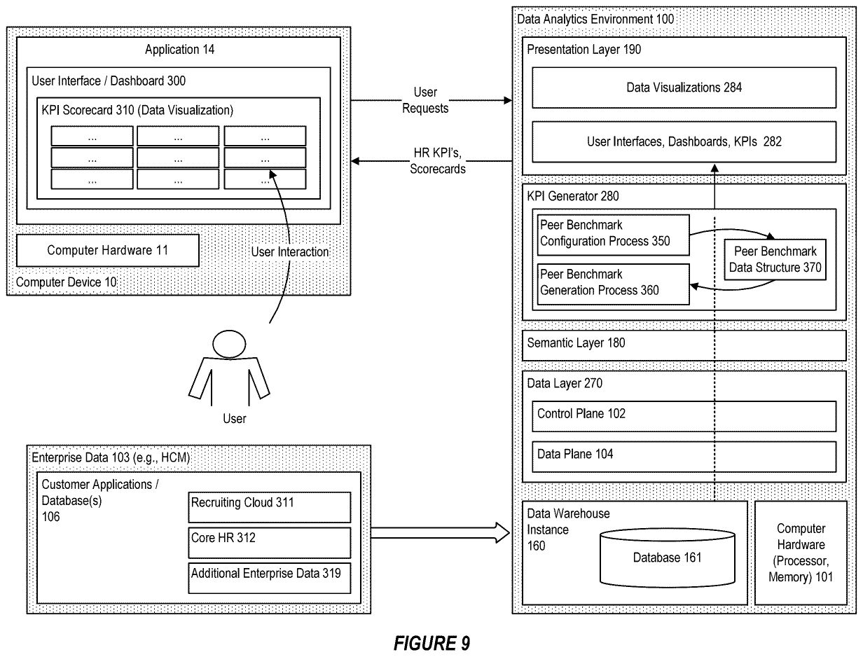

FIG. 9 illustrates a system for use with an enterprise application environment for determination of peer benchmarks, in accordance with an embodiment.

As illustrated in FIG. 9, in accordance with an embodiment, a data analytics environment as described above and provided by, or otherwise operating at, a computer system having a computer hardware (e.g., processor, memory), and including one or more software components and providing access to a data warehouse instance, can include, for example as part of a KPI generator, a peer benchmark configuration process 350, and peer benchmark generation process 360, that operate on a peer benchmark data structure 370, to configure and generate peer performance indicators or benchmarks.

In accordance with an embodiment, peer benchmarking can be used within an enterprise organization to provide people leaders with business intelligence data or key performance indicators that extend beyond their own organizational team.

For example, peers can be defined by default as people reporting to the same manager. Enterprise customers or users can create peer groups and members, and customize peer definitions, for example a selection of dimensions or measures of interest, to suit their particular requirements. The users can then extend their key performance indicators, dashboards, or scorecards with additional insights such as engagement scores, business outcomes such as quota attainment, service tickets closed, revenue, or profit.

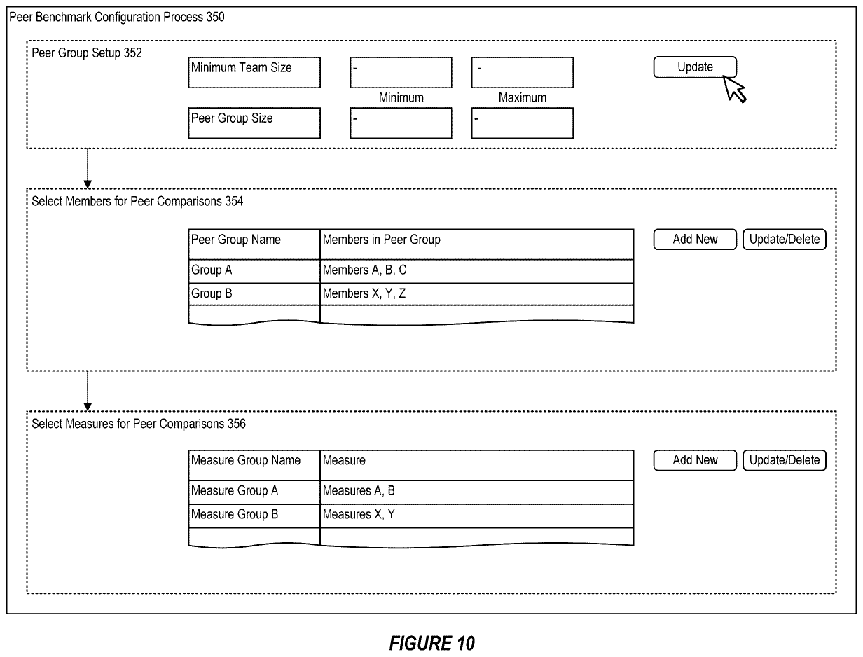

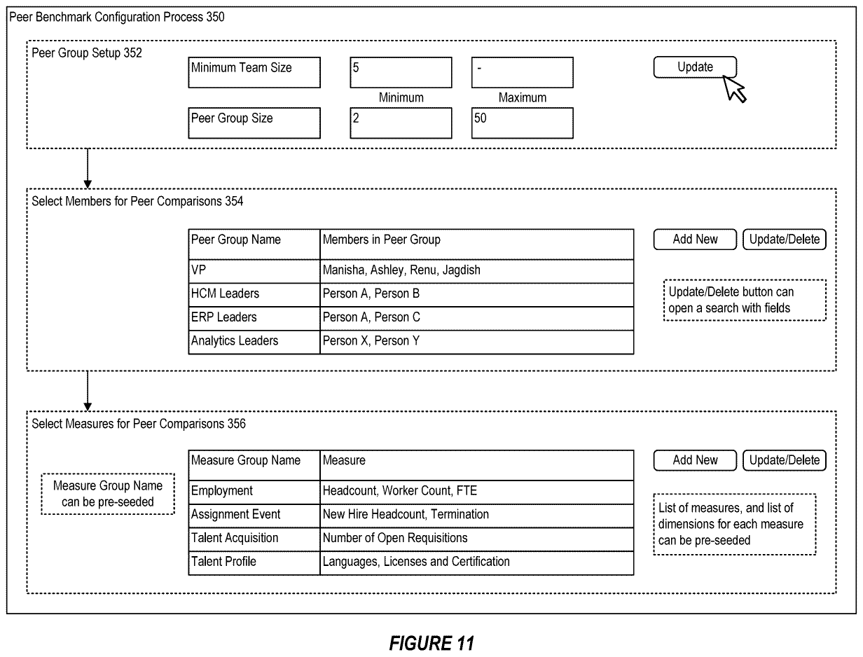

FIGS. 10-11 illustrate a process for configuration of a peer benchmark, in accordance with an embodiment.

As illustrated in FIGS. 10-11, in accordance with an embodiment, as part of a peer benchmark configuration process, the system can display user interfaces that receive, from a user, an indication of peer group setup 352, a selection of members for peer comparisons 354, and a selection of measures for peer comparisons 356.

For example, in accordance with an embodiment, a user can configure the system to utilize a minimum team size of, e.g., 5 members. The user can also indicate peer groups, such as for example VP, HCM Leaders, ERP Leaders, or Analytics Leaders, along with a selection of members for each peer group; and measure groups or names of interest, for example Employment, or Talent Acquisition, together with relevant measures or dimensions, for example Headcount, or Number of Open Requisitions.

In accordance with an embodiment, the system can automatically determine particular members for inclusion in particular peer groups, either as default members or by applying rules associated with those peer groups. Similarly, in accordance with an embodiment, the various measure groups or names, measures, and dimensions can be automatically pre-seeded by the system by applying various rules, and/or further modified by the user as they wish to suit their particular requirements.

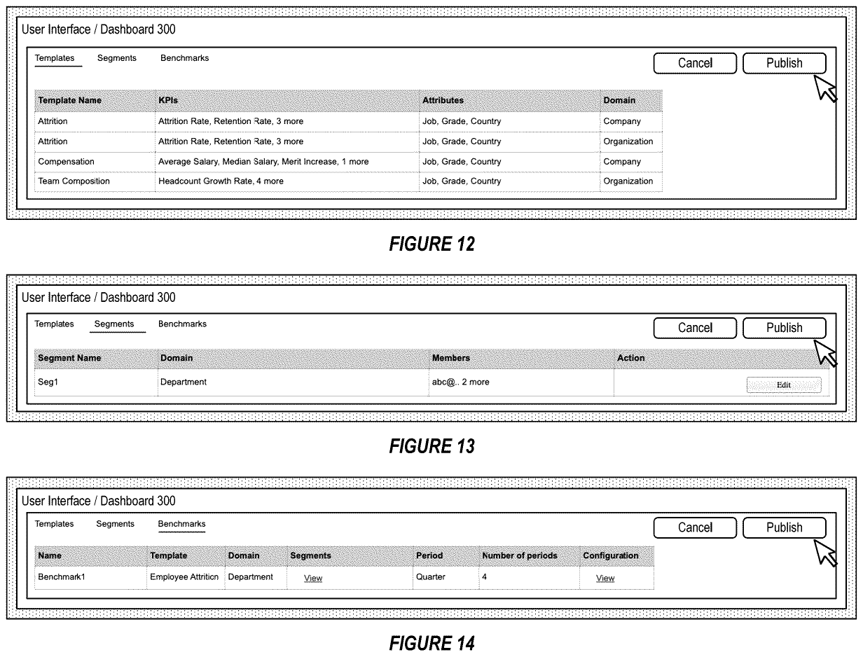

FIGS. 12-14 illustrate an example user interface for use in configuring a peer benchmark, in accordance with an embodiment.

As illustrated in FIGS. 12-14, in accordance with an embodiment, the system can provide a user interface that allows the user to configure templates for use in determining peer benchmarks (as illustrated in FIG. 12), segments (as illustrated in FIG. 13), and benchmarks (as illustrated in FIG. 14).

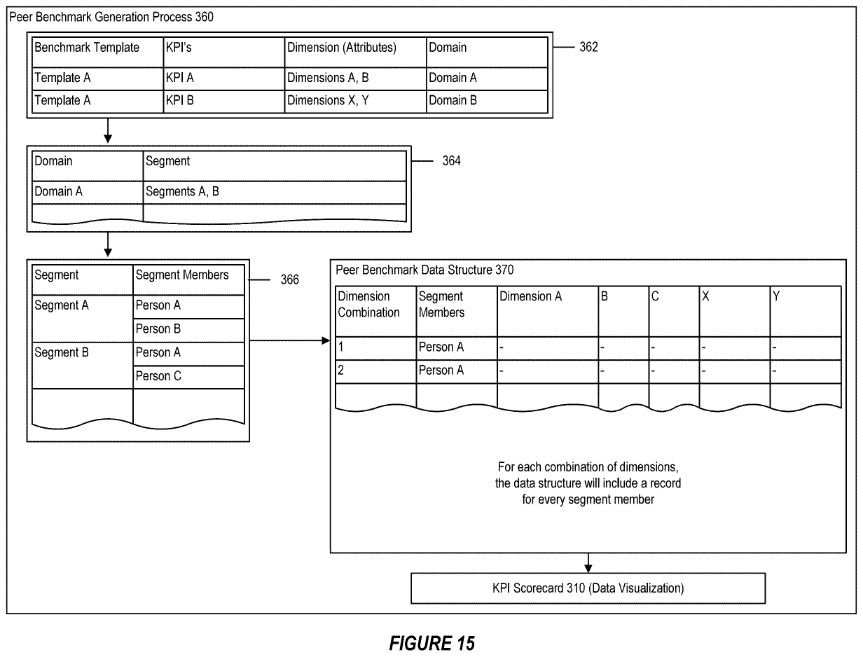

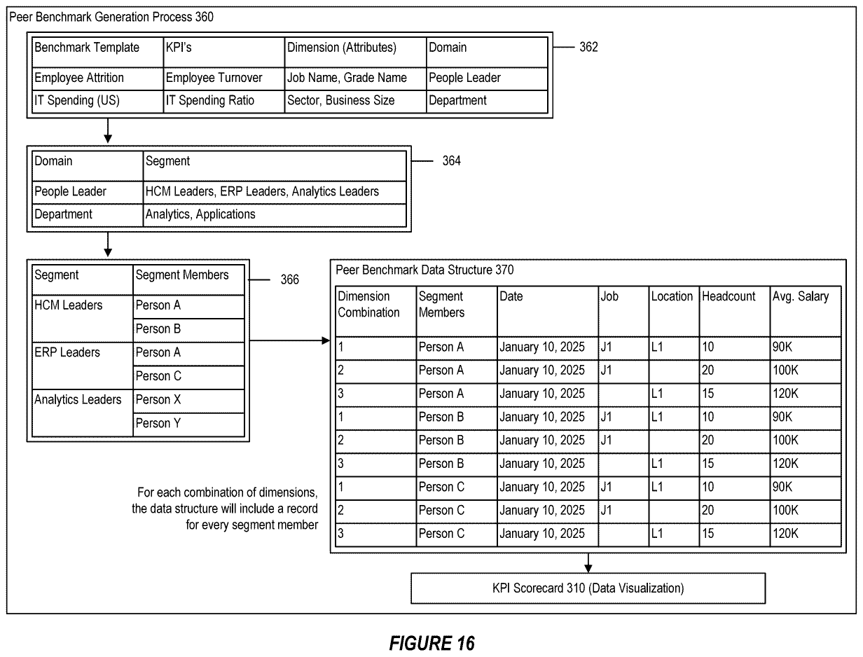

FIGS. 15-16 illustrate the use of the system or process for generation of peer benchmarks, in accordance with an embodiment.

As illustrated in FIGS. 15-16, in accordance with an embodiment, the peer benchmark generation process, which can be provided for example as part of a KPI generator, operates on a peer benchmark data structure 370, to generate peer performance indicators or benchmarks.

In accordance with an embodiment, the system includes one or more benchmark template 362, domain definition 364, and segment table 366, which can be used to generate a dashboard of peer benchmarks. A user can choose to create a dashboard and select KPIs of interest. Certain predefined benchmarks can be also be made available.

For example, to configure a peer group of employee attrition or IT spending, the user can select domain attributes such as, for example, job name, or grade name; and select domains such as, for example, people leader, or department. The configuration provided by the user can be used to define the template, segment and segment members, for example to define segments such as people leaders, including HCM leaders or ERP leaders, and then which actual persons are members of the HCM leaders, or ERP leaders, groups.

In accordance with an embodiment, the template, segment, and segment members as configured are then used by the system to assess the enterprise data, and to populate a data structure which is used to generate, at a user interface, key performance indicators, dashboards, or scorecards, for example as a two-dimensional data visualization that compares peer-to-peer characteristics, benchmarks, or other insights. For each combination of dimensions, the data structure will include a record for every segment member.

In accordance with an embodiment, since the system allows the user to define who is part of which peer groups, the people in the peer groups can access metrics within that peer group—but are not allowed to access metrics beyond their defined peer group. In this way, the dashboard contents are generally driven by the definition of the peer groups, and who is a member of the peer group—taking into account privacy concerns and only displaying peer benchmark data which the user is entitled to see.

In accordance with an embodiment, such dynamic selection enables intuitive authoring and real-time filtering but requires limiting dimensions for usability and performance. Additional factors associated with this approach include:

Seamless authoring experience to select KPIs and dimensions just like any other subject area. This allows the system to provide an intuitive self-service experience for business users.

Enable real-time filtering by allowing users to select dimensions combinations in the user interface.

The system dynamically maps selections to the applicable physical tables/rows.

The data model can support multiple dimensions, but users can choose up to three dimensions per benchmark to balance usability, scalability and performance.

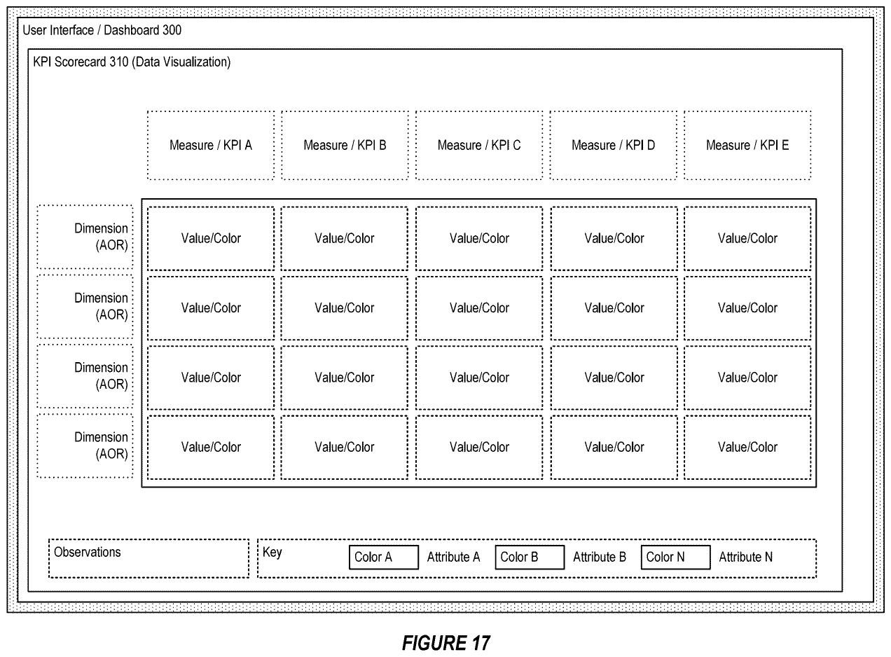

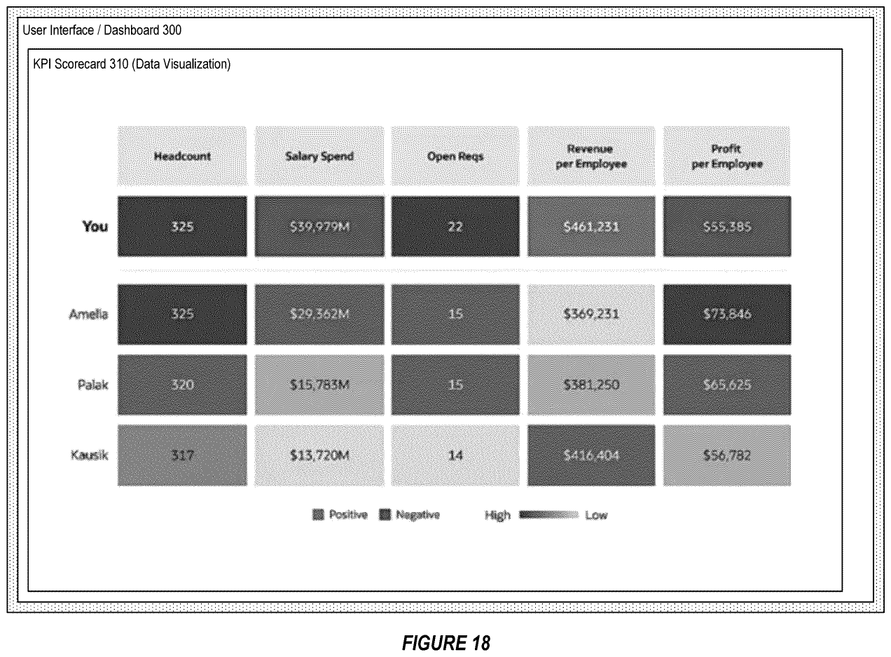

FIG. 17 illustrates an example user interface for displaying key performance indicators, dashboards, or scorecards, in accordance with an embodiment; while FIG. 18 illustrates an example use of the user interface to display peer benchmarks, in accordance with an embodiment.

As illustrated in FIGS. 17-18, in accordance with an embodiment, subsequent to determining the peer benchmarks associated with one or more peers, the system can indicate within the user interface or dashboard various KPIs or measures with values or colors. Optionally, the system can display observations or insights related to the data. Organizations have the flexibility to define peer groups and members which are appropriate to that organization, and then for the members of a peer group to run benchmarks to assess their performance against those of their peers. For example, a user can then click on or interact with the visualization to drill-down into the data and assess peer benchmark KPI's or other information. Entities such as managers within an organization can compare their KPIs with other managers.

### Peer Eligibility

In accordance with an embodiment, the system provides a means of allowing a user to provide a configuration for defining a minimum size of the team.

For example, if the team size is configured as (equal to) a latest pipeline run date, then the worker count should be (greater than or equal to) a minimum size of the team defined. With regard to a peer benchmark period, snapshot KPIs can be generated as of the last pipeline run date. Events KPI's can be generated as of last 60 days. Both primary assignment and primary work-relationships can be considered.

### Definition of Peers and Peer Groups

In accordance with an embodiment, the system is configured to only show an appropriate level of information to eligible peers—for example, a line manager with a team size more than or equal to the default team size defined in the peer eligibility.

For example, for each peer group, a minimum of 2 to a maximum of 10 line managers can be added as peers. A minimum of 1 and a maximum of X peer groups can be created. A user can be a member or part of multiple peer groups. Tables 1 and 2 illustrate various examples of member group names, and measure group names, together with members (managers) and dimensions or measures of interest, in accordance with an embodiment,

TABLE 1

| Member Group Name | Managers in Peer Group |
|---|---|
| VP | Mohan, John |
| HCM Leaders | Mohan, Liam |
| Customer Excellence | Arun, Brian, Jose |

TABLE 2

| Measure Group Name | Measures |
|---|---|
| Employment | Headcount, Worker Count, FTE |
| Assignment Event | Termination, New Hire Count |
| Compensation | Average Compa-Ratio |

### Example Scenarios

In accordance with an embodiment, the system can support various scenarios, examples of which are illustrated in Table 3.

TABLE 3

| Scenario | Expected Behavior |
|---|---|
| Line Manager added in Peer Group | Peer Group definitions will remain unchanged. |
| are no longer meeting the default | Since it is customer defined - unless customer |
| team size criteria. They have lesser | updates/removes/deletes. |
| than default team size required | Default team size - set by customers will be evaluated at |
| number. They are no longer LINE | subject area level before rending the data. |
| MANAGERS. Peer got terminated. | |
| Customer manually changes | Customer can create new Peer Group or update the |
| definition of the Peer Group | definition of existing Peer group by adding/removing |
| | new Peers in the Peer Group. We can offer a reset |
| | option on the Peer Benchmark Config to Reset/Reload |
| | like regular pipeline ops. So that new Peer Group can be |
| | populated. |
| KPI Selected and Incremental | Refresh KPI dataset after daily incremental pipeline. This |
| behavior | will be after regular pipeline - so that no SLO related |
| | implications are raised for this derived dataset. |

### Configurations

In accordance with an embodiment, while selecting KPIs, users can specify a minimum permitted value for that particular KPI. If for any dimension and measure combination the value is less than permitted value set—then the system will render a value of 0.

For example, if a manager added as part of peer group lost 3 workers and now has an overall team size less than the minimum default, then with this minimum value required configuration-such managers can be restricted from seeing data or any slicing of information can also be validated against this minimum value before rendering any data.

### Supported Measures

In accordance with an embodiment, as described above, snapshot KPIs can be generated as of the last pipeline run date; and events KPI's can be generated as of last 60 days. The system can include an application user interface that allows a user to select any measures from the available metadata, as illustrated by way of example in Table 4.

TABLE 4
Measure Group
Name

| | | | |
|---|---|---|---|
| Employment | HCM - | Workforce | Headcount |
| | Workforce | Headcount Facts - | Employee Headcount |
| | Core | Workforce | Contingent Worker Headcount |
| | | Headcount | FTE |
| | | | Employee FTE |
| | | | Contingent Worker FTE |
| | | | Manager Count |
| Employment | | Workforce | Worker Count |
| | | Headcount Facts - | Top Performer |
| | | Workforce | High Potential |
| | | Person Count | |
| Assignment Events | | Workforce | Hire Headcount |
| | | Headcount Facts - | Promotion Headcount |
| | | Workforce | Termination Headcount |
| | | Events | Hire Count |
| | | | Promotion Count |
| | | | Termination Count |
| Assignment Events | | Workforce | Voluntary Termination Count |
| | | Headcount Facts - | Involuntary Termination Count |
| | | Workforce | Voluntary Termination Headcount |
| | | Attrition | Involuntary Termination |
| | | | Headcount |
| Employment | | Workforce | Worker Male Gender Ratio |
| | | Headcount | Worker Female Gender Ratio |
| | | Facts-Workforce | |
| | | Diversity | |
| Compensation | HCM - | Worker | Average Compa-Ratio |
| | Workforce | Assignment | |
| | Rewards - | Salary - Facts- | |
| | Salary Basis | Worker Salary - | |
| | | Salary Monetary | |
| | | Measure | |

### Supported Dimensions

In accordance with an embodiment, the system can expose within the application user interface only dimension names and all attributes mentioned under the dimension, to reduce an additional level of configuration by customers, as illustrated by way of example in Table 5.

TABLE 5
Measure Group
Name

| | | | |
|---|---|---|---|
| Employment / | HCM - | Common - Job | Job Code |
| Assignment Event / | Workforce | | Job Name |
| Compensation | Core | | Job Family |
| | | | Job Family Code |
| | | | Job Level |
| | | | Job Level Code |
| | | Common - Grade | Grade Name |
| | | | Grade Code |
| | | Common - | Country Code |
| | | Country | Country Name |

### Example Implementation

In accordance with an embodiment, benchmarks provide context, helping organizations compare performance, spot gaps and drive improvements. For example, in people analytics, where HR lacks standardization, benchmarks offer a crucial reference point for decision-making. Internal peer benchmarks, such as survey results, help compare teams, departments, or locations for fair assessment and targeted actions. The described approach provides additional utility in combining such survey data with internal operational data, and extending peer benchmarks to operational insights for deeper analysis, allowing companies to compare themselves with similar organizations.

In accordance with an embodiment, an example approach can include:

Setting-up benchmarks to support desired KPIs (for example, headcount, gender ratio, top performer count, average compa-ratio) and related dimensions.

Creating peer groups (e.g., EVPs, HCM leaders, analytics managers) and assign individuals.

Assigning the benchmarks available for each peer group. The system can then aggregate insights that are visible to peers. Benchmarks are calculated only if there are X individuals that match the criteria.

Defining peers based on rules (for example, managers reporting to the same superior, or all managers in a particular country or region).

Expanding KPI's for example beyond HCM to include characteristics such, as example, survey, financials, and outcomes like quota attainment, service tickets closed,

Enable industry benchmarks to compare, for example “My Company vs Companies like ours”.

Aggregate data: benchmarks are created at an aggregate grain, like business unit, department manager, or country level, rather than at an individual grain.

Precomputed metrics: some metrics like headcount can roll up, but others like compa-ratio and attrition cannot be dynamically calculated (because the system cannot recalculate from individual grain).

Privacy Compliance: benchmarks are not shown for population below a security threshold (e.g., managers with fewer than 5 employees).

Precompute clients: when a benchmark KPI supports two dimensions, the data model precomputes distinct values for each combination. For example, the system can save Attrition for the Peer Member, and by specific grade, location, or a combination of the two.

To ensure the right benchmark value is played in the presentation layer, the system can utilize a variety of approaches: for example, dynamic selection enables intuitive authoring and real-time filtering but requires limiting dimensions for usability and performance; while direct mapping (1:1) supports many dimensions but requires trained authors to select the right ones; and there is no real-time filtering in consumption mode.

### Peer Benchmark Process

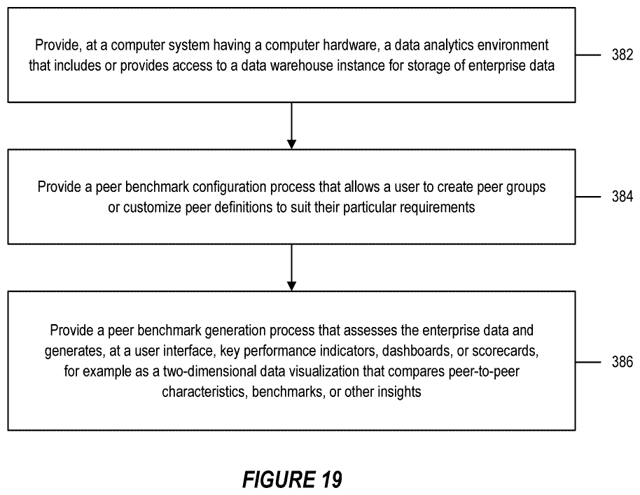

FIG. 19 illustrates an example process for use with an enterprise application environment for determination of peer benchmarks, in accordance with an embodiment.

As illustrated in FIG. 19, in accordance with an embodiment, at step 382, the process or method includes providing, at a computer system having a computer hardware, a data analytics environment that includes or provides access to a data warehouse instance for storage of enterprise data.

At step 384, the process or method includes providing a peer benchmark configuration process that allows a user to create peer groups or customize peer definitions to suit their particular requirements.

At step 386, the process or method includes providing a peer benchmark generation process whereby the system can assess the enterprise data and generate, at a user interface, key performance indicators, dashboards, or scorecards, for example as a two-dimensional data visualization that compares peer-to-peer characteristics, benchmarks, or other insights.

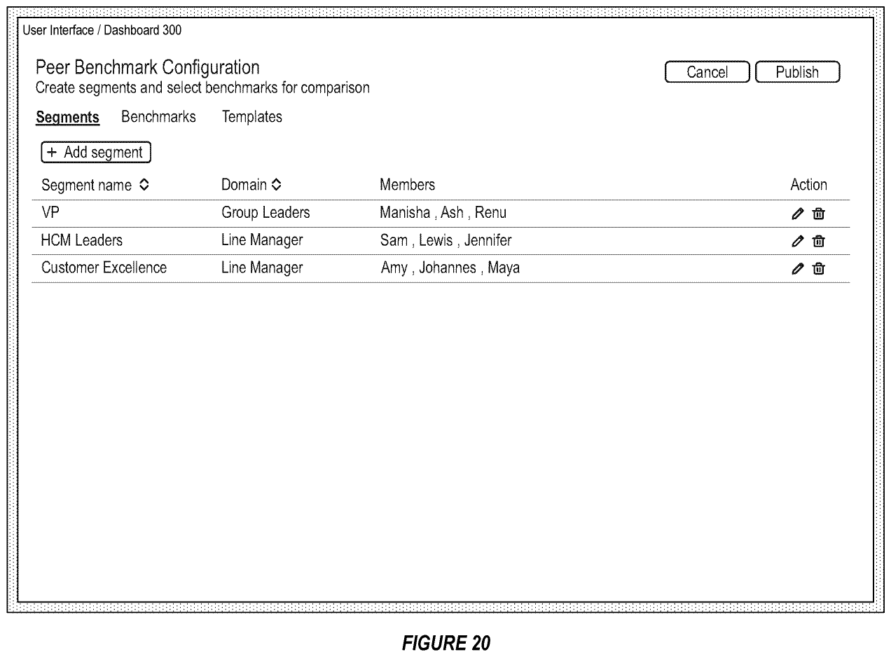

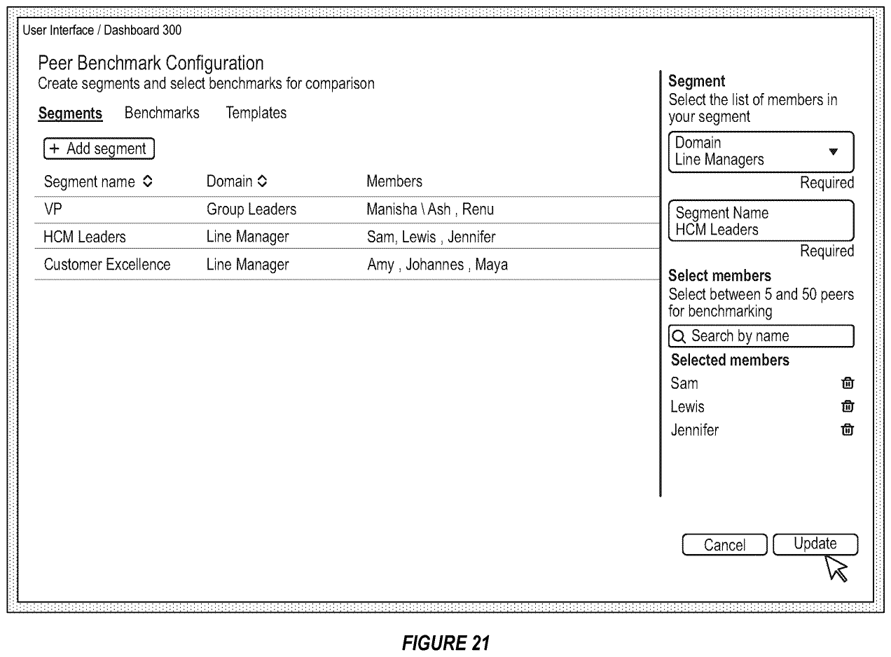

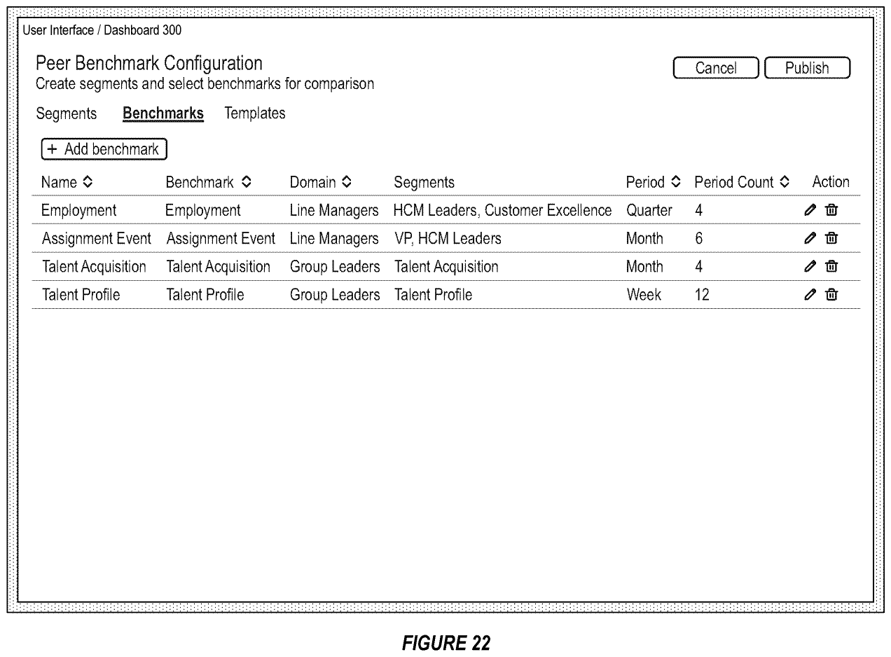

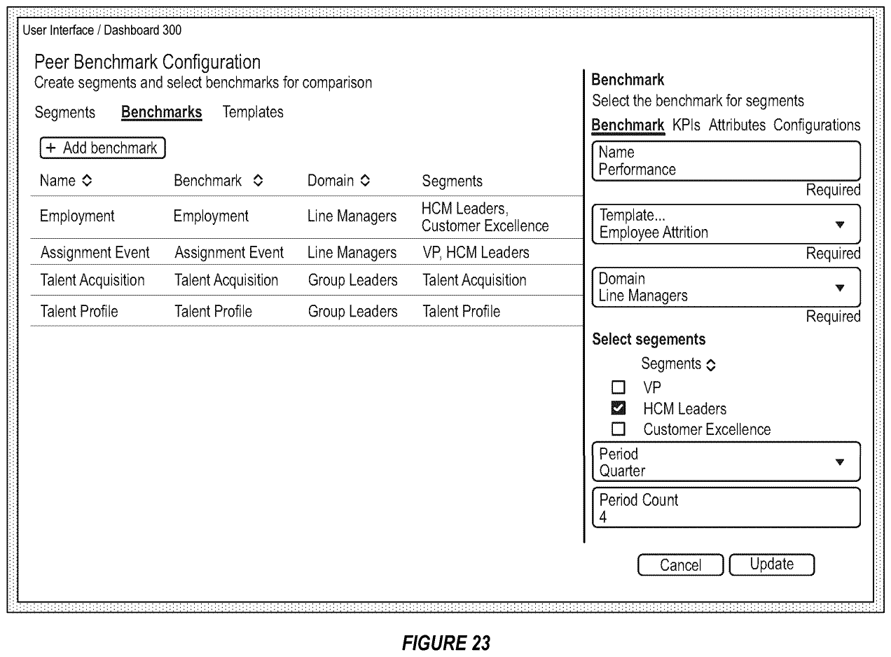

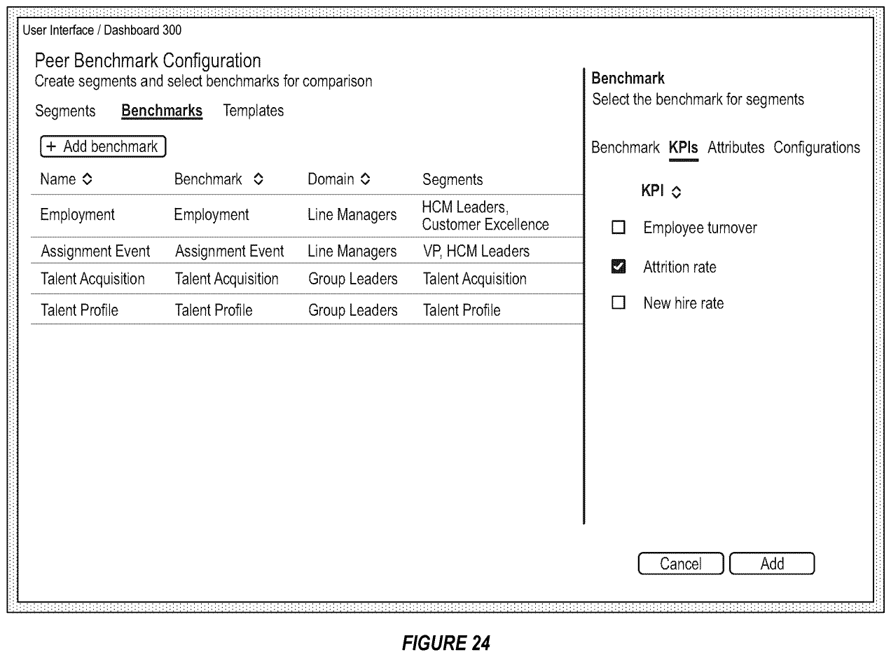

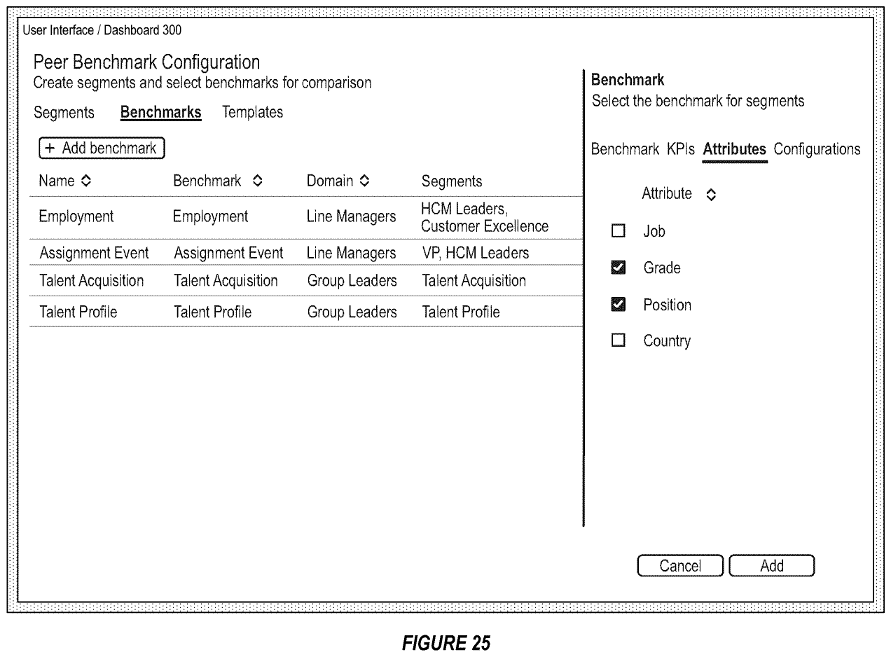

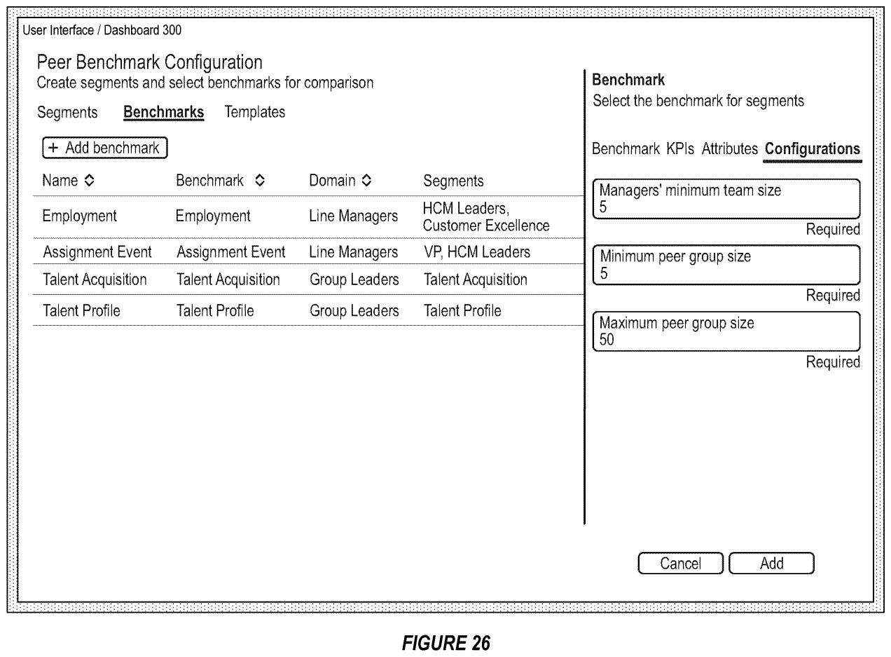

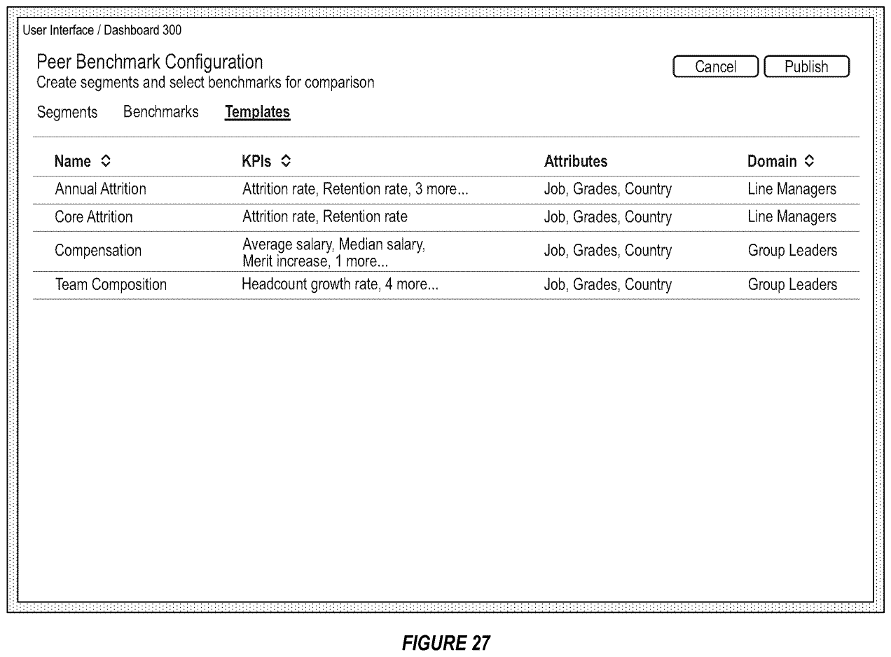

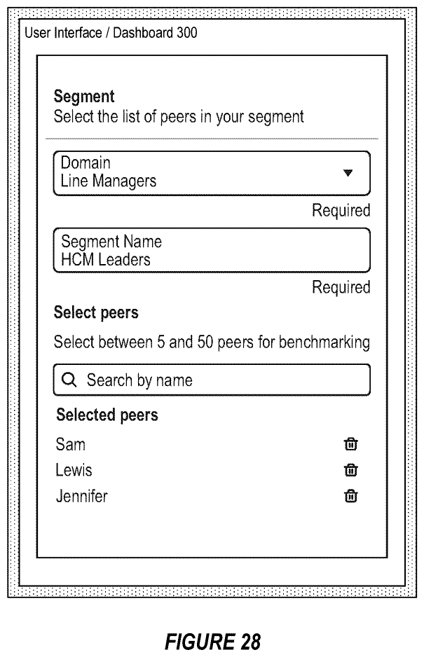

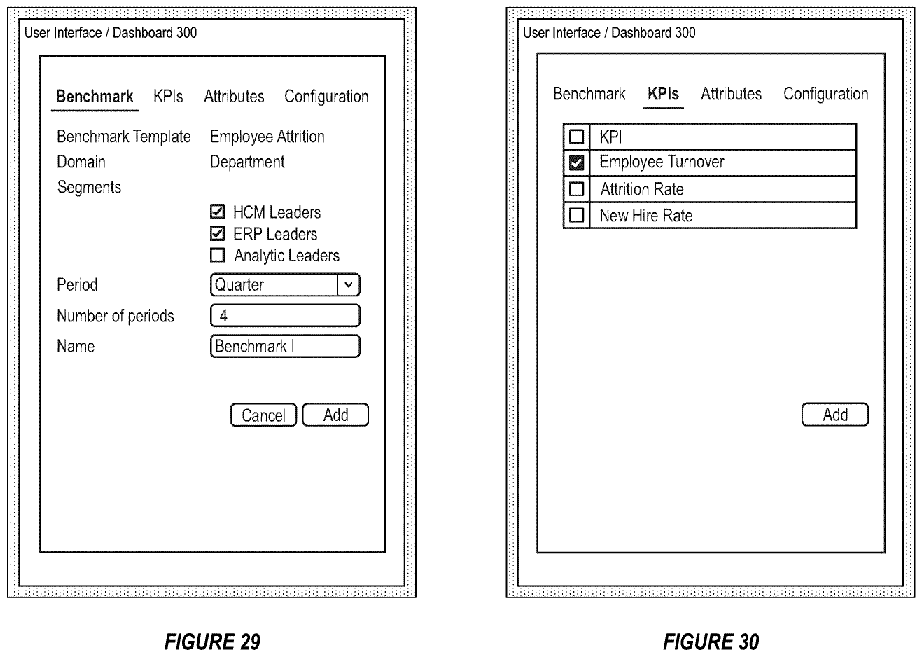

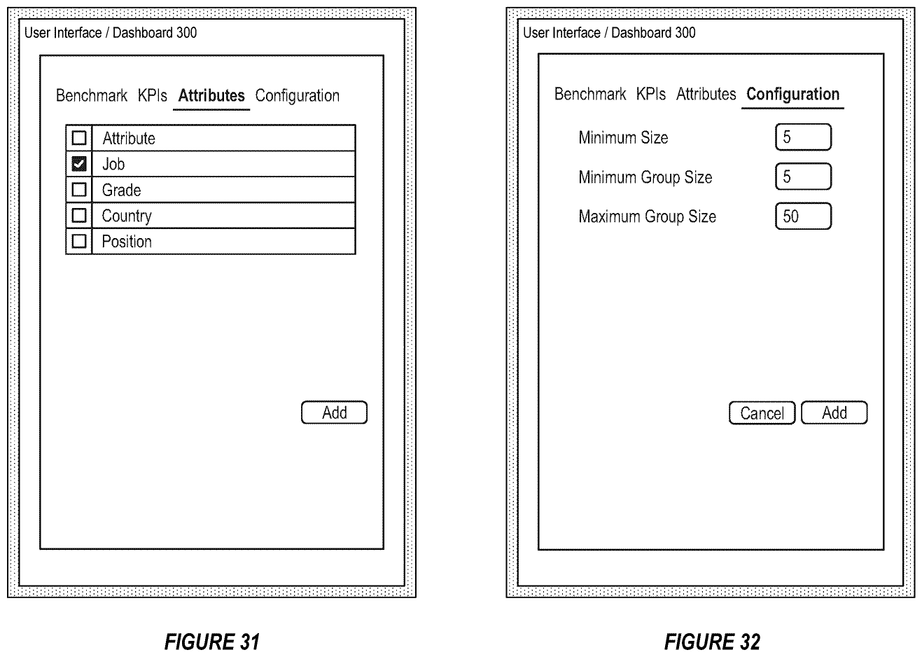

FIGS. 20-32 illustrate example user interfaces for configuring and using a system to generate and display peer benchmarks, in accordance with an embodiment.

As illustrated in FIGS. 20-32, in accordance with an embodiment, the system can provide a user interface by which a user can define templates, domains, segments, and members that comprise peer groups, or customize peer definitions to suit particular requirements. Using the above-described approach, the system can then assess the enterprise data across various dimensions or measures, and generate key performance indicators, dashboards, or scorecards, for example as a two-dimensional data visualization that compares peer-to-peer characteristics, benchmarks, or other insights.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

What is claimed is:

1. A system for use with an enterprise application environment for determination of peer benchmarks, comprising:
a data analytics system that operates to receive an enterprise data from an organization's enterprise software environment, and provides computer-executable processes and data structures for use in configuring and generating peer performance indicators or benchmarks;
wherein the system provides a user interface by which a user can define templates, domains, segments, and members that comprise peer groups, or customize peer definitions to suit particular requirements;
wherein the system can then assess the enterprise data across various dimensions or measures, and generate key performance indicators, dashboards, or scorecards that compares peer-to-peer characteristics, benchmarks, or other insights.

2. The system of claim 1, wherein the system can automatically determine particular members for inclusion in particular peer groups, either as default members or by applying rules associated with those peer groups;
wherein various measure groups or names, measures, and dimensions can be automatically pre-seeded by the system by applying various rules, and/or further modified by the user as they wish to suit their particular requirements.

3. The system of claim 1, wherein the system includes a peer benchmark configuration process, and peer benchmark generation process, that operate on a peer benchmark data structure, to configure and generate peer performance indicators or benchmarks.

4. The system of claim 1, wherein a configuration provided by the user is used to define one or more segment and segment members, which are then used by the system to assess the enterprise data, and to populate a data structure which is used to generate, at a user interface, key performance indicators, dashboards, or scorecards, as a two-dimensional data visualization that compares peer-to-peer characteristics, benchmarks, or other insights, wherein for each combination of dimensions, the data structure will include a record for every segment member.

5. The system of claim 1, wherein the system is provided within a cloud environment and accessed via a cloud service.

6. A method for use with an enterprise application environment for determination of peer benchmarks, comprising:
receiving at a data analytics system an enterprise data from an organization's enterprise software environment; and
providing computer-executable processes and data structures for use in configuring and generating peer performance indicators or benchmarks;
wherein the system provides a user interface by which a user can define templates, domains, segments, and members that comprise peer groups, or customize peer definitions to suit particular requirements;
wherein the system can then assess the enterprise data across various dimensions or measures, and generate key performance indicators, dashboards, or scorecards that compares peer-to-peer characteristics, benchmarks, or other insights.

7. The method of claim 6, wherein the system can automatically determine particular members for inclusion in particular peer groups, either as default members or by applying rules associated with those peer groups;
wherein various measure groups or names, measures, and dimensions can be automatically pre-seeded by the system by applying various rules, and/or further modified by the user as they wish to suit their particular requirements.

8. The method of claim 6, wherein the system includes a peer benchmark configuration process, and peer benchmark generation process, that operate on a peer benchmark data structure, to configure and generate peer performance indicators or benchmarks.

9. The method of claim 6, wherein a configuration provided by the user is used to define one or more segment and segment members, which are then used by the system to assess the enterprise data, and to populate a data structure which is used to generate, at a user interface, key performance indicators, dashboards, or scorecards, as a two-dimensional data visualization that compares peer-to-peer characteristics, benchmarks, or other insights, wherein for each combination of dimensions, the data structure will include a record for every segment member.

10. The method of claim 6, wherein the system is provided within a cloud environment and accessed via a cloud service.

11. A non-transitory computer readable storage medium having instructions thereon, which when read and executed by a computer cause the computer to perform a method comprising:
receiving at a data analytics system an enterprise data from an organization's enterprise software environment; and
providing computer-executable processes and data structures for use in configuring and generating peer performance indicators or benchmarks;
wherein the system provides a user interface by which a user can define templates, domains, segments, and members that comprise peer groups, or customize peer definitions to suit particular requirements;
wherein the system can then assess the enterprise data across various dimensions or measures, and generate key performance indicators, dashboards, or scorecards that compares peer-to-peer characteristics, benchmarks, or other insights.

12. The non-transitory computer readable storage medium of claim 11, wherein the system can automatically determine particular members for inclusion in particular peer groups, either as default members or by applying rules associated with those peer groups;
wherein various measure groups or names, measures, and dimensions can be automatically pre-seeded by the system by applying various rules, and/or further modified by the user as they wish to suit their particular requirements.

13. The non-transitory computer readable storage medium of claim 11, wherein the system includes a peer benchmark configuration process, and peer benchmark generation process, that operate on a peer benchmark data structure, to configure and generate peer performance indicators or benchmarks.

14. The non-transitory computer readable storage medium of claim 11, wherein a configuration provided by the user is used to define one or more segment and segment members, which are then used by the system to assess the enterprise data, and to populate a data structure which is used to generate, at a user interface, key performance indicators, dashboards, or scorecards, as a two-dimensional data visualization that compares peer-to-peer characteristics, benchmarks, or other insights, wherein for each combination of dimensions, the data structure will include a record for every segment member.

15. The non-transitory computer readable storage medium of claim 11, wherein the system is provided within a cloud environment and accessed via a cloud service.
